(19) United States
(12) Patent Application Publication
(10) Pub. No.: US 2025/0236193 A1
(43) Pub. Date: Jul. 24, 2025

(54) FLIGHT VEHICLE AND MAAS PROVISION METHOD

(71) Applicant: TOYOTA JIDOSHA KABUSHIKI KAISHA, Toyota-shi (JP)

(72) Inventors: Yoshifumi OTAKI, Nisshin-shi (JP); Hirofumi Taniguchi, Yokohama-shi (JP); Hiroto Tsukamoto, Wako-shi (JP); Toshimitsu Saijo, Nisshin-shi (JP); Daisaku Higashi, Nagoya-shi (JP); Naoya Oka, Nagoya-shi (JP); Daiki Kaneichi, Tokyo (JP)

(73) Assignee: TOYOTA JIDOSHA KABUSHIKI KAISHA, Toyota-shi (JP)

(21) Appl. No.: 18/888,352

(22) Filed: Sep. 18, 2024

(30) Foreign Application Priority Data
Jan. 23, 2024 (JP) 2024-008290

(51) Int. Cl. B60L 53/36; B60L 53/12

(52) U.S. Cl. CPC B60L 53/36; B60L 53/12; B60L 2200/10

(57) ABSTRACT

The disclosure relates to a battery driven flight vehicle including a control unit, and a battery. In the battery driven flight vehicle, when the flight vehicle takes off while performing wireless charging, the control unit performs a flight control to extend a time period staying in a wirelessly chargeable area compared to when the flight vehicle takes off without performing wireless charging.

### CROSS-REFERENCE TO RELATED APPLICATION

This application claims priority to Japanese Patent Application No. 2024-008290 filed on Jan. 23, 2024, incorporated herein by reference in its entirety.

### BACKGROUND

### 1. Technical Field

The present disclosure relates to a battery driven flight vehicle and a Mobility as a Service (MaaS) provision method.

### 2. Description of Related Art

Conventionally, technology is disclosed in which a power reception device that receives power by a magnetic resonance type contactless power supply, and a propulsion generation mechanism that obtains propulsion for flight by the power received by the power reception device, are provided in a flight vehicle (for example, WO 2017/203590).

### SUMMARY

Conventionally, charging technology during takeoff of a battery driven flight vehicle has not been examined. Namely, there is room for improvement in technology related to wireless charging of a flight vehicle.

In view of the circumstances, an objective of the present disclosure is to improve technology related to wireless charging of a battery driven flight vehicle.

A flight vehicle relating to an embodiment of the present disclosure is
a battery driven flight vehicle, and includes:
a control unit; and
a battery.

When the flight vehicle takes off while performing wireless charging, the control unit performs a flight control to extend a time period staying in a wirelessly chargeable area compared to when the flight vehicle takes off without performing wireless charging.

According to an embodiment of the present disclosure, technology related to wireless charging of a battery driven flight vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block-diagram showing a schematic configuration of a flight vehicle; and

FIG. 3 is a flowchart illustrating an operation of the flight vehicle.

### DETAILED DESCRIPTION OF EMBODIMENTS

Hereinafter, an embodiment of the present disclosure will be described.

### Outline of Embodiment

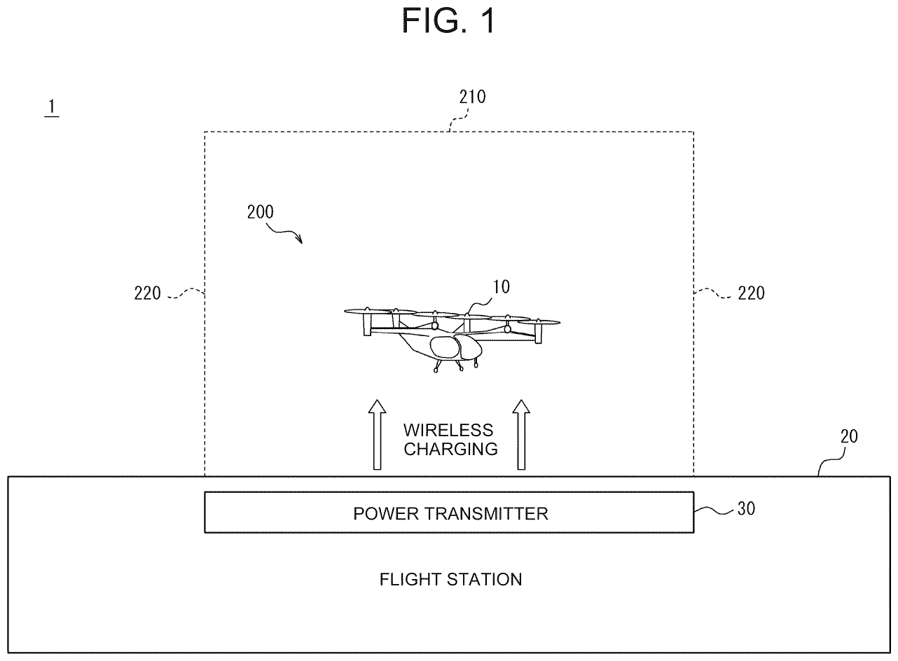

An outline of the system 1 according to the present embodiment will be described with reference to FIG. 1. The system 1 includes a flight vehicle 10 and a flight station 20.

The flight vehicle 10 according to the present embodiment includes an electric rotor blade and is driven by a battery. For example, the flight vehicle 10 is an electric vertical take-off and landing (eVTOL). eVTOL has a cabin of substantially the same size as a passenger car on which one or more passengers can ride, and mechanisms including one or more electric rotor blades for generating lift and thrust. eVTOL is at least partially steered by visual flight rules (VFR). The flight vehicle 10 is not limited to a eVTOL, and includes a helicopter, a drone, and the like. The flight vehicle 10 includes a drive mechanism including a motor for driving an electric rotor blade, a control unit thereof, and a battery for supplying electric power to the drive mechanism. The battery is, for example, a lithium-ion battery. The flight vehicle 10 may be operated by, for example, instrument flight rules (IFR).

The flight vehicle 10 can be wirelessly charged (hereinafter, also referred to as non-contact power supply) during takeoff. As a method of wireless charging, any method such as a magnetic resonance method, an electromagnetic induction method, an electric field coupling method, and a radio wave reception method may be adopted. When wireless charging is performed during takeoff, the flight vehicle 10 takes off from the flight station 20. The flight station 20 includes a power transmission device 30, and can wirelessly charge the flight vehicle 10 by the power transmission device 30.

The power transmission device 30 can wirelessly charge the flight vehicle 10 when the flight vehicle 10 is flying in the wirelessly chargeable area 200. In other words, the wirelessly chargeable area 200 is an area that can be wirelessly charged by the power transmission device 30. The wirelessly chargeable area 200 is defined by a height boundary 210 and a width boundary 220. The boundary 210 in the height direction and the boundary 220 in the width direction are determined by the output of the power transmission device 30.

First, the outline of the present embodiment will be described, and the details will be described later. The flight vehicle 10 according to the present embodiment is battery-driven, and is characterized in that, when the flight vehicle 10 takes off while wirelessly charging, the time of staying in the wirelessly chargeable area 200 is longer than when the flight vehicle 10 takes off without wirelessly charging.

As described above, according to the present embodiment, when the flight vehicle 10 takes off while being wirelessly charged, the time for the flight vehicle 10 to stay in the wirelessly chargeable area is increased. Therefore, the technology related to wireless charging of a battery-powered flight vehicle is improved in that the battery consumption of the flight vehicle 10 can be suppressed at the time of takeoff and thus the cruising distance can be made longer.

Next, each configuration of the flight vehicle 10 will be described in detail.

### Configuration of Flight Vehicle

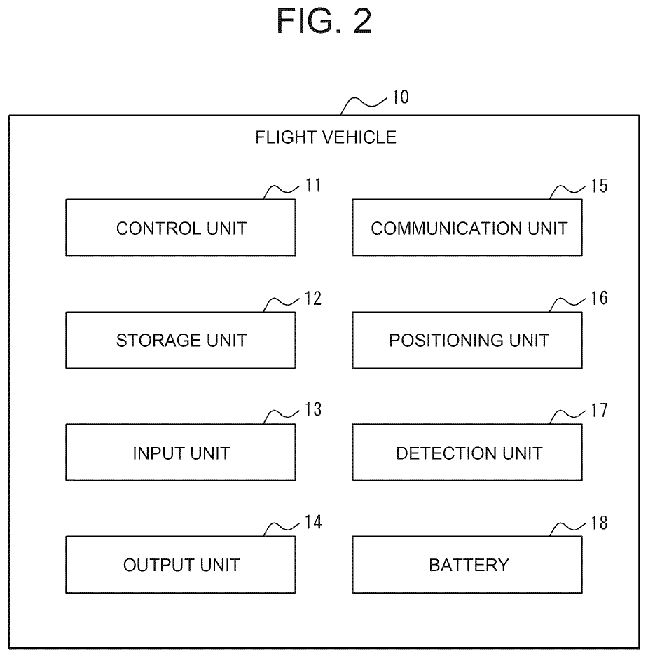

As illustrated in FIG. 2, the flight vehicle 10 includes a control unit 11, a storage unit 12, an input unit 13, an output unit 14, a communication unit 15, a positioning unit 16, a detection unit 17, and a battery 18.

The control unit 11 includes at least one processor, at least one dedicated circuit, or a combination thereof. A processor is a general-purpose processor such as a central processing unit (CPU), a graphics processing unit (GPU), or a special-purpose processor specialized for a particular process. The specialized circuit is, for example, a field-programmable gate array (FPGA), or an application specific integrated circuit (ASIC). The control unit 11 executes processing related to the operation of the flight vehicle 10 while controlling each unit of the flight vehicle 10. For example, the control unit 11 controls a drive mechanism including a motor for driving the electric rotor blade.

The storage unit 12 includes at least one semiconductor memory, at least one magnetic memory, at least one optical memory, or a combination of at least two of these. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read only memory (EEPROM). The storage unit 12 may function as, for example, a main storage device, an auxiliary storage device, or a cache memory. The storage unit 12 stores data used for the operation of the flight vehicle 10 and data obtained by the operation of the flight vehicle 10.

The input unit 13 includes at least one input interface. The input interface is, for example, a touch screen integrally provided with a physical key, a capacitive key, a pointing device, and a display. The input interface may be, for example, a sound sensor that receives voice input, a camera that receives gesture input, or the like. The input unit 13 receives an operation of inputting data used for the operation of the flight vehicle 10. Instead of being provided in the flight vehicle 10, the input unit 13 may be connected to the flight vehicle 10 as an external input device. As the connecting method, any method such as a universal serial bus (USB), a high-definition multimedia interface (HDMI (registered trademark)), or Bluetooth (registered trademark) can be used, for example.

The output unit 14 includes at least one output interface. The output interface is, for example, a display for outputting information in video, a speaker for outputting information in audio, or the like. The display may be, for example, a liquid crystal display (LCD), an organic electroluminescence (EL) display, or the like. The output unit 14 displays and outputs data obtained by the operation of the flight vehicle 10. Instead of being provided in the flight vehicle 10, the output unit 14 may be connected to the flight vehicle 10 as an external output device. As a connection method, for example, any method such as USB, HDMI (registered trademark), or Bluetooth (registered trademark) can be used.

The communication unit 15 includes at least one external communication interface. The communication interface may be either a wired communication or a wireless communication interface. For wired communication, the communication interface is, for example, a local area network (LAN) interface, a universal serial bus (USB). For wireless communication, the communication interface is an interface corresponding to a mobile communication standard such as long term evolution (LTE), 4th generation (4G), or 5th generation (5G), or an interface corresponding to short-range wireless communication such as Bluetooth. The communication unit 15 receives data used for the operation of the flight vehicle 10 and transmits data obtained by the operation of the flight vehicle 10.

The positioning unit 16 includes a sensor or a receiver for acquiring the position of the flight vehicle 10 by autonomous navigation, electronic navigation, a global navigation satellite system (GNSS), or the like. Sensors for autonomous navigation include, for example, acceleration sensors, gyro sensors, azimuth magnets, altimeters, etc. Receivers for electronic navigation include, for example, receivers for receiving radio waves from terrestrial radio facilities such as a VHF omni-directional radio range (VOR), an instrument landing system (ILS). Further, GNSS receiver includes, for example, a global positioning system (GPS), a quasi-zenith satellite system (QZSS), BeiDou, a global navigation satellite system (GLONASS), and/or Galileo. The positioning unit 16 acquires position information of the flight vehicle 10 and sends the position information to the control unit 11. Here, the position information includes altitude information of the flight vehicle 10.

The detection unit 17 has an interface with one or more sensors or sensors for detecting a state or an operation of each unit of the flight vehicle 10, and sends information indicating a detection result by the sensors to the control unit 11. The sensors include a drive mechanism including a motor, a sensor that detects a state or an operation such as a rotation speed of the propeller, a remaining charge amount of the battery 18, a temperature, and a charging speed. Further, the sensors include a wind speed sensor, a wind direction sensor, an air temperature sensor, an atmospheric pressure sensor, a humidity sensor, an illuminance sensor, a rainfall sensor, a camera, and the like that detect a state of an external environment of the flight vehicle 10.

The battery 18 supplies electric power to the driving mechanism of the flight vehicle 10. The battery 18 may be, for example, a lithium ion battery, a solid electrolyte battery, a nickel-metal hydride battery, or the like. The battery 18 can be wirelessly charged from the power transmission device 30.

### Operation of Flight Vehicle

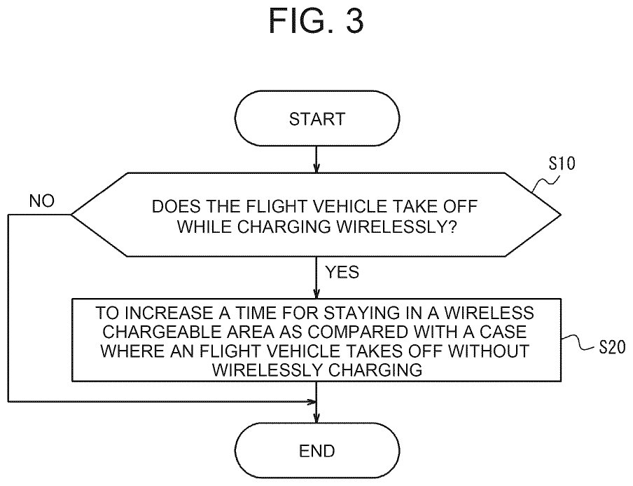

The operation of the system 1 according to the present embodiment will be described with reference to FIG. 3.

S10: The control unit 11 of the flight vehicle 10 determines whether the flight vehicle 10 takes off while wirelessly charging. Any method can be used for the determination processing. For example, the control unit 11 may perform the above-described determination processing based on a selection operation by the operator of the flight vehicle 10. Such a selection operation is a selection operation of either taking off while performing wireless charging or taking off without performing wireless charging. Alternatively, the control unit 11 may automatically determine whether to take off while performing wireless charging based on the planned flight path information of the flight vehicle 10, the remaining charge amount of the battery detected by the detection unit 17, the state of the external environment, and the like. If it is determined that the flight vehicle 10 takes off while wirelessly charging, processing proceeds to S20. On the other hand, when it is determined that the flight vehicle 10 does not take off while wirelessly charging (when it is determined that it takes off without wirelessly charging), the process ends.

S20: The control unit 11 increases the time of staying in the wirelessly chargeable area 200 as compared with the case where the flight vehicle 10 takes off without wirelessly charging.

Any method may be employed to increase the time the flight vehicle 10 stays in the wirelessly chargeable area 200. For example, typically during takeoff, the vehicle moves forward in the direction of the destination. Thus, for example, the control unit 11 may increase the time spent in the wirelessly chargeable area 200 by decreasing the forward speed of the flight vehicle 10. That is, in a case where the flight vehicle 10 takes off while wirelessly charging, the control unit 11 may perform control such that the forward speed becomes slower than in a case where the flight vehicle 10 takes off without wirelessly charging.

Alternatively, the control unit 11 may increase the time spent in the wirelessly chargeable area 200 by decreasing the ascending speed of the flight vehicle 10. That is, in a case where the flight vehicle 10 takes off while wirelessly charging, the control unit 11 performs control such that the ascending speed becomes slower than in a case where the flight vehicle 10 takes off without wirelessly charging.

Alternatively, the control unit 11 may increase the time spent in the wirelessly chargeable area 200 by using the altitude information of the flight vehicle 10 acquired by the positioning unit 16. For example, when the flight vehicle 10 takes off while wirelessly charging, the control unit 11 may perform flight control such that the forward speed is less than the prescribed speed until the prescribed altitude is reached. The prescribed altitude may be determined based on, for example, the height of the boundary 210 in the height direction of the wirelessly chargeable area 200. For example, the prescribed altitude may be the same as the height of the height boundary 210 of the wirelessly chargeable area 200. In this case, the forward speed of the flight vehicle 10 may be any forward speed as long as the speed is such that the flight vehicle 10 does not deviate from the wirelessly chargeable area 200 until the prescribed altitude is reached. Further, for example, when the flight vehicle 10 takes off while wirelessly charging, the control unit 11 may perform flight control such that the ascending speed is less than the prescribed speed until the prescribed altitude is reached.

As described above, in the case where the flight vehicle 10 takes off while being wirelessly charged, the flight vehicle 10 according to the present embodiment increases the time for the flight vehicle 10 to stay in the wirelessly chargeable area. Therefore, the technology related to wireless charging of a battery-powered flight vehicle is improved in that the battery consumption of the flight vehicle 10 can be suppressed at the time of takeoff and thus the cruising distance can be made longer.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the flight vehicle 10 may be distributed among a plurality of computers capable of communicating with each other. For example, an embodiment in which some of the components of the flight vehicle 10 are provided in an external server device is also possible.

Also, for example, the directivity and output of wireless charging may be controlled. For example, the power transmission device 30 may control the directivity of the wireless charging to be directed toward the flight vehicle 10 in accordance with the moving direction of the flight vehicle 10 based on a control instruction or the like from the flight vehicle 10. Further, for example, the power transmission device 30 may control to increase the output of the wireless charging when the flight vehicle 10 is separated from the power transmission device 30 by a predetermined distance.

In one embodiment, the flight vehicle 10 may be used to provide Mobility as a Service (MaaS), which is a mobility-based service. In one embodiment, the process of the flow chart of FIG. 3 may be executed when providing MaaS using the flight vehicle 10. In this case, the information processing method according to the above-described processing procedure is an exemplary method of providing MaaS using the flight vehicle 10.

What is claimed is:

1. A battery driven flight vehicle comprising:
a control unit; and
a battery, wherein when the flight vehicle takes off while performing wireless charging, the control unit performs a flight control to extend a time period staying in a wirelessly chargeable area compared to when the flight vehicle takes off without performing wireless charging.

2. The battery driven flight vehicle according to claim 1, wherein when the flight vehicle takes off while performing wireless charging, a forward speed is slow compared to when the flight vehicle takes off without performing wireless charging.

3. The battery driven flight vehicle according to claim 1, wherein
when the flight vehicle takes off while performing wireless charging, an ascending speed is slow compared to when the flight vehicle takes off without performing wireless charging.

4. The battery driven flight vehicle according to claim 1, wherein when the flight vehicle takes off while performing wireless charging, a forward speed is less than a prescribed speed until reaching a prescribed altitude.

5. The battery driven flight vehicle according to claim 1, wherein when the flight vehicle takes off while performing wireless charging, an ascending speed is less than a prescribed speed until reaching a prescribed altitude.

6. A Mobility as a Service provision method using the battery driven flight vehicle according to claim 1.
